(19) United States
(12) Patent Application Publication
(10) Pub. No.: US 2026/0286227 A1
(43) Pub. Date: Sep. 24, 2026

(54) APPARATUS AND METHOD FOR HEAT TREATMENT OF WOOD

(71) Applicant: Ernesto PAGNOZZI, Terni (IT)

(72) Inventor: Ernesto PAGNOZZI, Terni (IT)

(21) Appl. No.: 19/475,734

(22) PCT Filed: Mar. 26, 2024
(86) PCT No.: PCT/IB2024/052887

§ 371 Date: Oct. 15, 2025

(30) Foreign Application Priority Data
Apr. 18, 2023 (IT) 102023000007455

(51) Int. Cl. C10B 53/02; B01J 6/00; B27K 5/00; C10B 57/14; F27B 5/04; F27B 5/06; F27B 5/14; F27B 5/18; F27D 99/00

(52) U.S. Cl. CPC C10B 53/02; B01J 6/008; B27K 5/001; C10B 57/14; F27B 5/04; F27B 5/14; F27B 5/18; F27D 99/0003; F27B 2005/068

(57) ABSTRACT

A wood thermal treatment apparatus has a cell having a thermal treatment chamber housing a wood mass, an air circulation jacket adjacent to and fluidly isolated from the thermal treatment chamber by a thermally conductive partition wall and having an inlet collector and an outlet collector. A system for heating and cooling the thermal treatment taking chamber, a heating operating configuration and a cooling operating configuration, has a recirculation duct which in the heating operating configuration is connected between the inlet and outlet collectors so that an airflow introduced into and extracted from the air circulation jacket passes in the recirculation duct. In the heating operating configuration, the recirculation duct and the air circulation jacket form a closed circuit. A heating unit heats air flowing in the recirculation duct by combustion of wood waste resulting from wood processing. Flow diverter valves open the closed circuit in the cooling operating configuration.

### TECHNICAL FIELD OF THE INVENTION

The present description relates to the technical field of wood thermal treatment apparatuses and methods.

### TECHNOLOGICAL BACKGROUND OF THE INVENTION

The wood thermal treatment methods currently used in the industry substantially consist in performing, in sequence, the following three steps:
preheating the previously dried wood to bring it to residual moisture values close to zero in a treatment cell until the temperature thereof reaches the pyrolysis start temperature, within a temperature range of about 180° C.-230° C., with artifices preventing the combustion thereof;
a true thermal treatment, consisting in keeping the wood within the aforesaid temperature range for a preset time, preventing in any case and always the combustion thereof;
cooling the wood up to bringing it in any case to temperatures below 100° C. in order to then expose the wood to the external environment without the risk of combustion and/or thermal shock problems of the wood material.

European Patent EP 2535156 B1 describes certain embodiments of an apparatus comprising an autoclave cell for high-temperature wood thermal treatment. In particular, the apparatus described comprises:
1) an autoclave, in which a vacuum-tight thermal treatment chamber adapted to contain the wood is defined, provided with an airtight hatch for introducing and removing a support carriage of a stack of wood to be subjected to the thermal treatment itself into/from the thermal treatment chamber;
2) a system for heating the interior of the thermal treatment chamber, which can consist of electric batteries or finned-tube radiators for heating by means of vapor and/or diathermic oil, or of a diathermic oil jacket outside the thermal treatment chamber;
3) a ventilation system comprising one or more fans adapted to transfer the thermal energy from the heating system to the wood material by circulating the gas in the thermal treatment chamber;
4) a vacuum pump unit comprising a vacuum pump and possibly a condenser interposed between the vacuum pump and the thermal treatment chamber, adapted to condense any vapor and/or gas exiting the wood in order to provide for its storage in a suitable tank and its disposal;
5) a wood cooling system which can vary in the implementation thereof according to the version of the heating method;
6) a safety and alarm system which allows signaling and/or managing any dangerous situations.

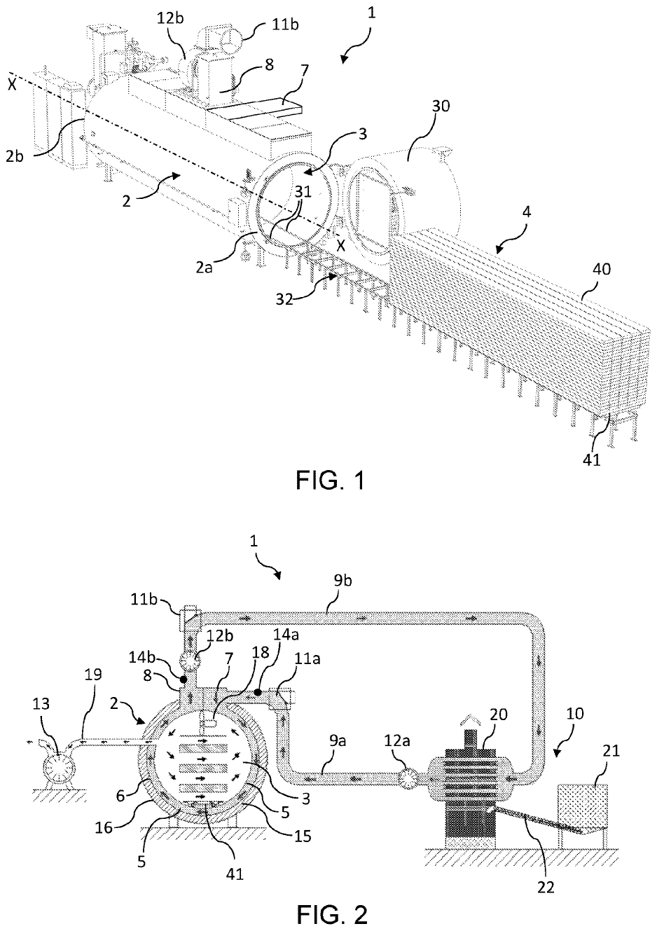

In particular, in the configuration in FIG. 1a of aforesaid European Patent EP 2535156 B1, the wood thermal treatment apparatus comprises a heating system having electric resistors arranged inside the thermal treatment chamber, and also having an air cooling system comprising an air circulation jacket arranged about the thermal treatment chamber. Therefore, in the aforesaid configuration, the heating of the thermal treatment chamber involves a significant consumption of electricity.

As is known, the current international economical and geopolitical situation has led to a significant increase in the cost of electricity, as well as of gas and diesel. This situation has made wood thermal treatment processes particularly costly since these involve significant energy consumption. Moreover, such an energy consumption is currently not very compatible with the following needs:
1) Reduction in pollution worldwide;
2) Growing demand for non-polluting thermal energy sources;
3) Disposal of wood material waste representing 70% of the total wood production;
4) Growing demand for and high costs of electricity, gas and diesel;
5) Simplification and maintenance of thermal energy production systems.

It is the object of the present invention to provide a solution which allows completely or partly solving the problems described above with reference to wood thermal treatment apparatuses and methods of the prior art.

This and other objects are achieved by a wood thermal treatment apparatus as defined in claim 1 in its most general form and in the dependent claims in some particular embodiments thereof. Such objects are also achieved by a wood thermal treatment method as defined in claim 12.

The invention will become more apparent from the following detailed description of embodiments thereof, given by way of non-limiting examples, with reference to the accompanying drawings, in which:

FIG. 1 shows an isometric view of a part of a wood thermal treatment apparatus according to a non-limiting embodiment of the present invention;

FIG. 2 shows a diagrammatic sectional view of the wood thermal treatment apparatus in FIG. 1, in a heating operating configuration;

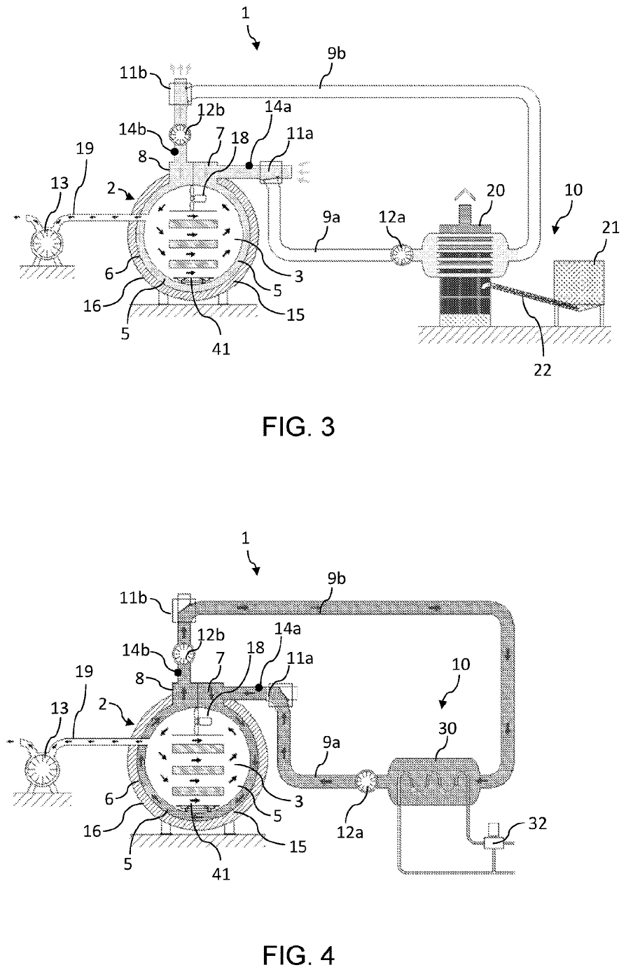

FIG. 3 shows a diagrammatic sectional view of the wood thermal treatment apparatus in FIG. 1, in a cooling operating configuration;

FIG. 4 shows a diagrammatic sectional view of a second embodiment of a wood thermal treatment apparatus in the heating operating configuration.

Equal or similar elements will be indicated by the same reference signs in the accompanying drawings.

FIG. 1 shows a non-limiting exemplary embodiment of a part of a wood thermal treatment apparatus 1 according to a non-limiting embodiment of the present invention. In the present description, the thermal treatment apparatus 1 will also be more briefly referred to as the apparatus 1 or the thermal treatment apparatus 1.

The wood thermal treatment apparatus 1 comprises a cell 2 comprising a thermal treatment chamber 3 adapted to house a wood mass 4 to be thermally treated. Preferably, the wood mass 4 comprises a plurality of wood boards 40 arranged so as to form a stack.

For example, cell 2 is, or comprises, a container body 16, for example a box-shaped or cylindrical container body, extending along a mainly longitudinal extension axis X-X between two opposite end portions 2a, 2b. In a normal use configuration of apparatus 1, the mainly longitudinal extension axis X-X a is conveniently a horizontal axis or a substantially horizontal axis. The outer walls of the container body 16 are preferably made of steel, e.g., stainless steel.

For example, the container body 16 has a length in the range of 6-15 meters along the mainly longitudinal extension axis X-X. If the container body 16 is a box-shaped container body, said body 16 has, for example, a rectangular cross section the sides of which have, for example, a length in the range of 2-4 meters. If the container body 16 is a cylindrical container body, it has, for example, a diameter in the range of 2 meters-4 meters. The wood mass 4 to be thermally treated has, for example, a volume in the range of 6 m³-70 m³. Each time a range of values is indicated in the present description, the end values of the range are intended as being included in the range.

Preferably, at least one of the two end portions 2a, 2b of the container body 16, in the example the end portion 2a, is an open end portion and the cell 2 comprises a vacuum-tight hatch 30 adapted to be opened and closed to open and occlude the open end portion 2a, respectively. The vacuum-tight hatch 30 is, for example, pivotally hinged to the container body 16, preferably by means of a cylindrical hinge conveniently having a vertical, or substantially vertical, hinge axis.

In the opening operating configuration shown in FIG. 1, the vacuum-tight hatch 30 allows introducing the wood mass 4 to be treated into the thermal treatment chamber 3 and extracting the wood mass 4 from the thermal treatment chamber 3 after the thermal treatment. In the closing operating configuration (not shown in the drawings), the vacuum-tight hatch 30 allows hermetically closing the thermal treatment chamber 3.

According to an advantageous embodiment, the wood mass 4 rests on a support carriage 41, equipped with wheels, for example. The thermal treatment chamber 3 comprises an inner rail 31 for the support carriage 41 to slide. Preferably, the apparatus 1 further comprises an outer rail 32, which is outside the thermal treatment chamber 3, on which the support carriage 41 and the wood mass 4 can be placed prior to being introduced into the thermal treatment chamber 3 and after being extracted from the thermal treatment chamber. Advantageously, the outer rail 32 is movable so as to be arranged contiguous to and aligned with the inner rail 31 to translate the support carriage 41 when inserting the carriage 41 and the wood mass 4 into the treatment chamber 3, and then to be moved in order to allow closing the vacuum-tight hatch 30. After the thermal treatment and upon cooling the wood mass 4, and also upon opening the vacuum-tight hatch, the outer rail 32 can be repositioned aligned with and contiguous to the inner rail 31 to allow the extraction of the wood mass 4 from the thermal treatment chamber 3.

Cell 2 comprises an air circulation jacket 5 arranged outside the thermal treatment chamber 3 which is adjacent to the thermal treatment chamber 3 and is fluidly isolated from the thermal treatment chamber 3 by at least one partition wall 6. This clearly implies that air flowing in the air circulation jacket 5 does not flow in the thermal treatment chamber 3. Said at least one partition wall 6 is a thermally conductive wall and, for example, is made of stainless steel or aluminum or a metal alloy having high thermal conductivity.

With reference to FIGS. 2 and 3, the air circulation jacket 5 comprises an inlet collector 7 for introducing air into the air circulation jacket 5 and an outlet collector 8 for extracting air from the air circulation jacket 5.

Conveniently, cell 2 comprises a thermal insulating layer 15 covering the air circulation jacket 5 on the opposite side with respect to the thermal treatment chamber 3. Said thermal insulating layer 15 is thus arranged between the partition wall 6 and an outer wall of the container body 16.

According to an advantageous embodiment, the air circulation jacket 5 transversely surrounds the thermal treatment chamber 3 at least in part. More advantageously, the air circulation jacket 5 transversely surrounds, e.g., circumferentially, continuously or substantially continuously, at least one longitudinal segment of the thermal treatment chamber 3, for example a longitudinal segment at least equal to 50%, or preferably at least equal to 90%, of the longitudinal extension of the thermal treatment chamber 3.

According to an advantageous embodiment, the apparatus 1 comprises a ventilation system having one or more fans 18 arranged inside the thermal treatment chamber 3, adapted to transfer to the wood mass the thermal energy of the fluid contained inside the thermal treatment chamber 3, which can be air or an inert gas, for example.

The wood thermal treatment apparatus 1 further comprises a system for heating and cooling the thermal treatment chamber 3, adapted to take a heating operating configuration and a cooling operating configuration. In the heating operating configuration, the heating and cooling system allows heating the thermal treatment chamber 3. Moreover, in the cooling operating configuration, the heating and cooling system allows cooling the thermal treatment chamber 3.

The heating and cooling system comprises a recirculation duct 9a, 9b, or a recirculation flow path 9a, 9b, which in the heating operating configuration is connected between the inlet collector 7 and the outlet collector 8 so that an airflow, which is introduced into and extracted from the air circulation jacket 5, passes in such a recirculation duct 9a, 9b. With reference to FIG. 2, in the heating operating configuration, the recirculation duct 9a, 9b and the air circulation jacket 5 form a closed circuit, more precisely a closed fluid path. For example, the recirculation duct 9a, 9b comprises an air delivery pipe 9a and an air return pipe 9b.

The heating and cooling system further comprises a heating unit 10 configured to heat air flowing in the recirculation duct 9a, 9b by combustion of wood waste resulting from wood processing, i.e., utilizing thermal energy generated by the combustion of wood waste material resulting from wood processing. Preferably, the heating unit 10 heats air flowing along a limited segment of the recirculation duct 9a, 9b and is arranged between the air return pipe 9b and the air delivery pipe 9a, for example. Hence, the air delivery pipe 9a is a pipe for delivering relatively hotter air and the air return pipe 9b is a pipe for returning relatively less hot air.

The heating and cooling system further comprises flow diverter means 11a, 11b configurable or controllable to open the aforesaid closed circuit in the cooling operating configuration of the heating and cooling system. Therefore, such flow diverter means 11a, 11b are such as to open the aforesaid closed circuit in the cooling operating configuration of the heating and cooling system. Preferably, in the cooling operating configuration, the flow diverter means 11a, 11b are such as to interrupt the fluid communication between the air circulation jacket 5 and the recirculation duct 9a, 9b. The cooling operating configuration is diagrammatically shown in FIG. 3. Preferably, the flow diverter means 11a, 11b are controlled electronically to establish and interrupt the fluid communication between the air circulation jacket 5 and the recirculation duct 9a, 9b.

According to an advantageous embodiment, the flow diverter means 11a, 11b comprise at least one flow diverter valve 11a arranged upstream of the inlet collector 7 and/or one flow diverter valve 11b placed downstream of the outlet collector 8. Preferably, said at least one diverter valve 11a, 11b comprises at least one gate valve.

According to a particularly advantageous embodiment, the thermal treatment apparatus 1 comprises means adapted to impose a forced air circulation in the closed circuit and in the air circulation jacket 5. For example, said means adapted to impose a forced air circulation in the closed circuit and in the air circulation jacket 5 comprise at least one fan 12a, 12b, preferably at least one centrifugal fan 12a, 12b.

Advantageously, said at least one fan 12a, 12b is operatively interposed:
between the outlet collector 8 and the flow diverter valve 11b placed downstream of the outlet collector; and/or
between the flow diverter valve 11a placed upstream of the inlet collector 7 and the inlet collector 7.

Preferably, said at least one fan 12a, 12b comprises a first fan 12a arranged upstream of the inlet collector 7 and a second fan 12b placed downstream of the outlet collector 8. In the accompanying drawings, the first fan 12a is operatively interposed between the heating unit 10 and the first flow diverter valve 11a, but in an alternative embodiment, the first fan 12a could be operatively interposed between the flow diverter valve 11a and the inlet collector 7.

If only one fan is to be used, it is convenient that said fan is:
configured and arranged to draw air from the air circulation jacket 5 and for example operatively interposed between the outlet collector 8 and the flow diverter valve 11b; or
configured and arranged to blow air into the air circulation jacket 5 and for example operatively interposed between the flow diverter valve 11a and the inlet collector 7.

According to an advantageous embodiment, the aforesaid means adapted to impose a forced air circulation in the closed circuit and in the air circulation jacket 5 allow imposing a forced air circulation in the air circulation jacket 5 in both the heating operating configuration and the cooling operating configuration.

According to an advantageous embodiment, in the heating operating configuration, the heating and cooling system is such as to achieve a temperature in the range of 180° C.-230° C. inside the thermal treatment chamber 3. The modification of the wood structure of the wood mass 4 occurs in this temperature range through multiple chemical-physical reactions of the substances forming it. Such multiple thermal-chemical reactions cause the following macroscopic modifications of the wood features:
COLOR: variation (darkening) and homogenization of the color in the entire thickness of the wood, the intensity of which can be controlled by means of suitable adjustments of the process parameters, i.e., temperature, pressure, and exposure time;
DURABILITY: improvement of the durability thereof, in the sense that the treated wood becomes more resistant to attacks by fungi and other xylophagous microorganisms, and therefore “soft” wood species with durability class 5, such as conifers (such as fir, pine, and larch) which are readily available and have low economic value, can achieve class 1, typical of “hard” wood notoriously considered very durable (such as oak, chestnut, and teak), the economical value of which can be 3-10 times higher than that of conifers;
HYGROSCOPICITY: reduction in the hygroscopicity of the wood, i.e., the ability thereof to take or absorb the humidity in the surrounding environment, making it almost insensitive to climate changes (temperature and air humidity);
DIMENSIONAL STABILITY: as a consequence of the reduction in hygroscopicity, the wood acquires great dimensional stability with reference to the variations in environmental humidity, the effect of which is reflected in the quality of the finished products (furniture, parquets, doors and windows, musical instruments, etc.) which become practically insensitive to climate changes;
MECHANICAL FEATURES: there have been detected a worsening of 10-15% of certain mechanical features (ensile, compressive and shear resistance), but a significant improvement in hardness; in other words, the thermally treated wood becomes a little more fragile but harder. This phenomenon, which could be partially limiting with reference to making structural beams for building construction, is absolutely advantageous in all the other applications because the increase in hardness not only facilitates certain processing of the wood material such as honing and painting, but allows obtaining items being more resistant to accidental scratches, an essential result for the final quality of the finished products, such as parquets, furniture, and doors and windows, etc.

According to a particularly advantageous embodiment, apparatus 1 further comprises a first temperature sensor 14a adapted to measure the temperature of the airflow entering into the air circulation jacket 5, and a second temperature sensor 14b adapted to measure the temperature of air exiting from the air circulation jacket 5. In the heating operating configuration, the heating and cooling system can thus be controlled based on a difference in temperature between the temperature of the incoming airflow and the temperature of the exiting air, for example so that such a difference is less than 15° C., for example equal to 10° C. or equal to about 10° C. For example, the heating and cooling system can be controlled by controlling the means adapted to impose a forced air circulation in the closed circuit and in the air circulation jacket, for example the speed of fan 12a and/or fan 12b. Additionally or alternatively, the heating and cooling system can be controlled, for example, by controlling the heating unit 10 so as to decrease or increase the heating power thereof.

Conveniently, the first temperature sensor 14a is arranged in the inlet collector 7 or immediately upstream thereof, and the second temperature sensor 14b is arranged in the outlet collector 8 or immediately downstream thereof.

According to an advantageous embodiment, the thermal treatment apparatus 1 further comprises a vacuum pump 13 operatively connected, for example by means of a pipe 19, to the thermal treatment chamber 3 and configured to cause a vacuum level in the range of 70-350 mBar of absolute pressure in the thermal treatment chamber 3. In the heating operating configuration, the vacuum pump 13 allows substances released following the heating of the wood mass to be drawn from the thermal treatment chamber 3. These substances can be condensed by providing a condenser operatively interposed between the thermal treatment chamber 3 and the vacuum pump 13 and communicating with a storage tank of said substances. Such substances can thus be disposed of, minimizing the environmental impact. Moreover, the combustion of the wood mass 4 is prevented by virtue of the combination of this vacuum level with the temperatures selected for the thermal treatment (range of 180° C.-230° C.), as already explained in greater detail in European Patent EP 2535156 B1.

According to an advantageous embodiment, as already explained in greater detail in European Patent EP 2535156 B1, the thermal treatment apparatus 1 is configured to perform the dual function of vacuum dryer and thermal treatment device so as to first dry the wood with temperatures between 50-100° C. and pressures between 50-350 mBar so as not to damage the wood itself while lowering the moisture thereof up to values close to zero, and then expose it to the “brutal” temperatures of the thermal-chemical modification treatment with temperatures of 180-230° C. and pressures of 70-350 mBar, again using the same thermal treatment chamber 3.

According to an advantageous embodiment, the heating unit 10 comprises a wood hot-air generator 20, for example a heater which generates hot air from the combustion of wood. In this embodiment, the heating unit 10 further comprises a storage silo 21 for wood waste resulting from wood processing, and an automated transport system 22 operatively interposed between the storage silo 21 and the wood hot-air generator 20, configured to supply the wood hot-air generator 20 with wood waste contained in the storage silo 21. The automated transport system 22 comprises, for example, a spiral conveyor preferably controllable in an automatic manner based on the thermal energy required in the heating operating configuration. In the heating operating configuration (FIG. 2), the hot air generator 20 is ON and is powered. In the cooling operating configuration (FIG. 3), the hot air generator 20 is OFF and is not powered.

According to an advantageous embodiment, the thermal treatment apparatus 1 comprises an electronic control unit (not shown in the figures) operatively connected to the heating and cooling system and configured, i.e., programmed, to control the operation of the heating and cooling system. For example, such an electronic control unit is operatively connected: to the first sensor 14a and/or to the second sensor 14b and/or to the heating unit 10 and/or to the means adapted to impose a forced air circulation in the closed circuit and in the air circulation jacket, and to the flow diverter means 11a, 11b and/or to the ventilation system 18 and/or to one or more sensors adapted to measure the temperature and/or the pressure and/or the humidity inside the thermal treatment chamber 3. The electronic control unit comprises a PLC (Programmable Logic Controller), for example.

FIG. 4 diagrammatically shows a second embodiment of the wood thermal treatment apparatus 1, which differs from the apparatus described hereto with reference to FIGS. 1-3 in that the heating unit 10 comprises a diathermic oil-air heat exchanger 30 or a saturated vapor-air heat exchanger 30 adapted to transfer thermal energy from diathermic oil or saturated vapor to air circulating in the recirculation duct 9a, 9b. In any case, also in this embodiment, the diathermic oil and saturated vapor can be generated by utilizing the thermal energy developed by the combustion of wood waste.

Note that the above description of the wood thermal treatment apparatus 1 also corresponds to the description of a wood thermal treatment method, comprising the steps of:
arranging a wood mass 4 to be treated in a cell 2 comprising a thermal treatment chamber 3 adapted to house said wood mass 4 to be treated, where cell 2 comprises an air circulation jacket 5 arranged outside the thermal treatment chamber 3 which is adjacent to the thermal treatment chamber 3 and is fluidly isolated from the thermal treatment chamber 3 by at least one partition wall 6;
heating an air mass by combustion of wood processing waste and introducing said heated air mass into the air circulation jacket causing it to pass through a recirculation duct operatively connected to the air circulation jacket 5 to heat the interior of the thermal treatment chamber and to carry out a wood thermal treatment at a temperature in the range of 180.00° C.-230.00° C.

At the end of said thermal treatment, the method further comprises a step of cooling said wood mass by opening the recirculation duct to introduce air drawn from the external environment into the air circulation jacket 5, and progressively lowering the temperature inside the thermal treatment chamber 3.

A non-limiting operating example of the wood thermal treatment apparatus 1 described above will be now described with reference to FIGS. 1-3.

The vacuum thermal treatment preferably occurs in four subsequent steps, in which the apparatus takes the configuration in FIG. 2:

Step 0: Preheating wood at the absolute pressure of 300 mBar (vacuum) with constant increase in temperature from ambient temperature up to reaching the start treatment temperature equal to 180° C.;

Step 1: first pressure (for example, to bring the absolute pressure to 316 mBar) and temperature (192° C.) level and waiting until the wood reaches the step-1 temperature; Step 2: second pressure (for example, to bring the absolute pressure to 333 mBar) and temperature (203° C.) level and waiting until the wood reaches the step-2 temperature; Step 3: third pressure (for example, to bring the absolute pressure to 350 mBar) and temperature (215° C.) level, being final treatment values, and keeping them for the time required to ensure the effectiveness of the treatment.

At the end of step 3, the cooling step is started: this step consists in bringing the apparatus back to the configuration in FIG. 3 to circulate cold ambient air in the air circulation jacket 3 in order to cool the wood to a final temperature of 40-60° C.

For example, in the cooling step, the following operations are performed:
I. Switching OFF the hot air generator 20 by interrupting feeding of wood waste;
II. Deactivating the fan 12a;
III. Opening the valve 11a to allow cold air to be drawn from the environment;
IV. Maintaining the operation of fan 12b for the forced circulation of cold air in the jacket 3;
V. Opening the gate valve 11b to release drawn air from the jacket 3.

As for the operation of the embodiment in FIG. 4, the operation is completely similar to that described above, except for the fact that, for example, the heating unit 10 comprises a valve 32 which allows activating the diathermic oil or saturated vapor flow in the exchanger 30 in the heating operating configuration, and interrupting said flow in the cooling operating configuration.

Based on the above description, it is possible to understand how the suggested thermal treatment apparatus and method allow fully achieving the preset objects with reference to the prior art. Indeed, the suggested thermal treatment apparatus and method allow:
1) Reducing pollution worldwide;
2) Coping with a growing demand for non-polluting thermal energy sources;
3) Disposing of wood material waste representing 70% of the total production of wood;
4) Circumventing the problem caused by the growing demand for and high costs of electricity and/or gas and/or diesel;
5) Increasing the safety of wood thermal treatment operations.

In relation to points 1)-3), it should be noted indeed that from a pollution point of view, the use of wood residues-waste as fuel is an essential fact, considering the following factors:
the amount of CO₂ emitted by the wood in the combustion is equal to that absorbed by the tree when it was living and therefore there is substantially no increase in CO2;
by burning fossil fuel such as carbon and petroleum products, amounts of CO2 absorbed by forests for millions of years are put back into the atmosphere, and therefore the concentration of CO2 is increased;
a disposal of the wood residues-waste is automatically determined because they are incinerated during the combustion thereof.

Without prejudice to the principle of the present invention, the embodiments and the constructional details may be broadly varied with respect to the above description merely disclosed by way of non-limiting example, without departing from the scope of protection as defined in the appended claims.

1-13. (canceled)

14. A wood thermal treatment apparatus, comprising:
a cell comprising a thermal treatment chamber adapted to house a wood mass to be treated, wherein the cell comprises an air circulation jacket arranged outside the thermal treatment chamber, which is adjacent to the thermal treatment chamber and fluidly isolated from the thermal treatment chamber by at least one thermally conductive partition wall so that air flowing in the air circulation jacket does not flow in the thermal treatment chamber, wherein the air circulation jacket comprises an inlet collector for introducing the air into the air circulation jacket and an outlet collector for extracting the air from the air circulation jacket;
a heating and cooling system for heating and cooling the thermal treatment chamber, adapted to take a heating operating configuration and a cooling operating configuration;
wherein the heating and cooling system comprises:
a recirculation duct which in the heating operating configuration is connected between the inlet collector and the outlet collector so that an airflow, which is introduced into and extracted from the air circulation jacket, passes in the recirculation duct, wherein in the heating operating configuration, the recirculation duct and the air circulation jacket form a closed circuit;
a heating unit configured to heat air flowing in the recirculation duct by combustion of wood waste resulting from wood processing; and
flow diverter means configurable to open the closed circuit in the cooling operating configuration of the heating and cooling system.

15. The wood thermal treatment apparatus of claim 14, wherein the flow diverter means comprise at least one flow diverter valve placed upstream of the inlet collector and/or a flow diverter valve placed downstream of the outlet collector.

16. The wood thermal treatment apparatus of claim 15, wherein the at least one flow diverter valve comprises at least one gate valve.

17. The wood thermal treatment apparatus of claim 14, comprising means adapted to impose a forced air circulation in the closed circuit and in the air circulation jacket.

18. The wood thermal treatment apparatus of claim 17, wherein the means adapted to impose the forced air circulation in the closed circuit and in the air circulation jacket comprise at least one fan.

19. The wood thermal treatment apparatus of claim 15, comprising means adapted to impose a forced air circulation in the closed circuit and in the air circulation jacket, wherein the means adapted to impose the forced air circulation in the closed circuit and in the air circulation jacket comprise at least one fan, and wherein the at least one fan is operatively interposed:
between the outlet collector and the flow diverter valve placed downstream of the outlet collector; and/or
between the flow diverter valve placed upstream of the inlet collector and the inlet collector.

20. The wood thermal treatment apparatus of claim 18, wherein the at least one fan comprises a first fan placed upstream of the inlet collector and a second fan placed downstream of the outlet collector.

21. The wood thermal treatment apparatus of claim 14, wherein in the heating operating configuration, the heating and cooling system achieves a temperature in a range of 180° C.-230° C. inside the thermal treatment chamber.

22. The wood thermal treatment apparatus of claim 14, further comprising a vacuum pump operatively connected to the thermal treatment chamber and configured to cause a vacuum level in a range of 70-350 mBar of absolute pressure in the thermal treatment chamber.

23. The wood thermal treatment apparatus of claim 14, wherein the heating unit comprises a wood hot-air generator.

24. The wood thermal treatment apparatus of claim 23, wherein the heating unit further comprises a storage silo for the wood waste resulting from the wood processing, and an automated transport system operatively interposed between the storage silo and the wood hot-air generator, configured to supply the wood hot-air generator with the wood waste contained in the storage silo.

25. The wood thermal treatment apparatus of claim 14, wherein the heating unit comprises a diathermic oil-air heat exchanger or a saturated vapor-air heat exchanger adapted to transfer thermal energy from diathermic oil or saturated vapor to the air circulating in the recirculation duct.

26. A wood thermal treatment method, comprising:
arranging a wood mass to be treated in a cell comprising a thermal treatment chamber adapted to house the wood mass to be treated, wherein the cell comprises an air circulation jacket arranged outside the thermal treatment chamber, which is adjacent to the thermal treatment chamber and fluidly isolated from the thermal treatment chamber by at least one thermally conductive partition wall so that air flowing in the air circulation jacket does not flow in the thermal treatment chamber;
heating an air mass by combustion of wood processing waste and introducing the heated air mass into the air circulation jacket, causing the heated air mass to pass through a recirculation duct operatively connected to the air circulation jacket to heat an interior of the thermal treatment chamber and carry out a wood thermal treatment at a temperature in a range of 180° C.-230° C.; and
at the end of the wood thermal treatment, cooling the wood mass by opening the recirculation duct to introduce air drawn from an external environment into the air circulation jacket, and progressively lowering the temperature inside the thermal treatment chamber.
